(19) United States
(12) Patent Application Publication
(10) Pub. No.: US 2007/0116332 A1
(43) Pub. Date: May 24, 2007

(54) Vessel segmentation using vesselness and edgeness

(75) Inventors: Wenli Cai, Dorchester, MA (US); Dongqing Chen, Setauket, NY (US); Frank C. Dachille, Amityville, NY (US)

Correspondence Address: F. CHAU & ASSOCIATES, LLC, 130 WOODBURY ROAD, WOODBURY, NY, 11797, US

(73) Assignee: VIATRONIX INCORPORATED, Stony Brook, NY (US)

(21) Appl. No.: 10/580,742

(22) PCT Filed: Nov. 24, 2004
(86) PCT No.: PCT/US04/39698

§ 371 Date: May 26, 2006

Related U.S. Application Data
(60) Provisional application No. 60/525,603, filed on Nov. 26, 2003.

(51) Int. Cl. G06K 9/00; G06K 9/34

(52) U.S. Cl. 382/128; 382/173

(57) ABSTRACT

A system (100) and corresponding method for vessel segmentation are provided, the system having an adapter (112, 128, 130) for receiving image data, a processor (102) in signal communication with the input adapter, a pre-processing unit (170) in signal communication with the processor for pre-processing the received image data, and a vessel segmentation unit (180) in signal communication with the processor for segmenting vessels using pre-processed data; and the corresponding method including receiving image data, pre-processing the received data, and segmenting vessels responsive to the pre-processed data.

### CROSS-REFERENCE TO RELATED APPLICATION

This application claims priority to U.S. Provisional Patent Application Ser. No. 60/525,603, filed Nov. 26, 2003, which is incorporated herein by reference in its entirety.

### BACKGROUND

The present disclosure relates to the performance of virtual examinations. More particularly, the disclosure provides a system and method for vessel segmentation.

Two-dimensional (2D) visualization of human organs using medical imaging devices has been widely used for patient diagnosis. Currently available medical imaging devices include computed tomography (CT) and magnetic resonance imaging (MRI), for example. Three-dimensional (3D) images can be formed by stacking and interpolating between two-dimensional pictures produced from the scanning machines. Imaging an organ and visualizing its volume in three-dimensional space would be beneficial due to the lack of physical intrusion and the ease of data manipulation. However, the exploration of the three-dimensional volume image must be properly performed in order to fully exploit the advantages of virtually viewing an organ from the inside.

With the progress of multi-detector computerized tomography (MDCT) and increasing temporal and spatial resolution of data sets, clinical use of computerized tomographic angiography (CTA) is increasing. Vessel segmentation can be quite challenging, but it is needed to isolate vascular structures.

Radiologists and other specialists have historically been trained to analyze scan data consisting of two-dimensional slices. However, while stacks of such slices may be useful for analysis, they do not provide an efficient or intuitive means to navigate through virtual organs, especially ones as complex as vascular structures. There remains a need for a virtual examination system providing data in a conventional format for analysis while, in addition, allowing an operator to easily navigate among vessels and vascular structures.

### SUMMARY

These and other drawbacks and disadvantages of the prior art are addressed by a system and method for vessel segmentation using vesselness and edgeness.

A system and corresponding method for vessel segmentation are provided. A system embodiment has an input adapter for receiving image data, a processor in signal communication with the input adapter, a pre-processing unit in signal communication with the processor for pre-processing the received image data, and a vessel segmentation unit in signal communication with the processor for segmenting vessels using pre-processed data. A corresponding method embodiment includes receiving image data, pre-processing the received data, and segmenting vessels responsive to the pre-processed data.

These and other aspects, features and advantages of the present disclosure will become apparent from the following description of exemplary embodiments, which is to be read in connection with the accompanying drawings.

### BRIEF DESCRIPTION OF THE DRAWINGS

FIG. 1 shows a schematic diagram of a system for vessel segmentation using vesselness or edgeness in accordance with an embodiment of the present disclosure;

FIG. 2 shows a schematic diagram of a vessel model with a Gaussian luminance profile in accordance with an embodiment of the present disclosure;

FIG. 3 shows histograms from an aorta computerized tomographic angiography (CTA) scanning with and without contrast agent in accordance with an embodiment of the present disclosure;

FIG. 4 shows plot diagrams for CTA intensity ranges and the significant point in each range in accordance with an embodiment of the present disclosure; and

FIG. 5 shows a schematic diagram of a multi-level filter in accordance with an embodiment of the present disclosure.

### DETAILED DESCRIPTION OF EXEMPLARY EMBODIMENTS

The present disclosure provides system and method embodiments for vessel segmentation using vesselness and edgeness. With the progress of multi-detector computerized tomography (MDCT) and increasing temporal and spatial resolution of data sets, clinical use of computerized tomographic angiography (CTA) data sets is increasing. Vessel segmentation can be quite challenging, but it is needed to isolate vascular structures.

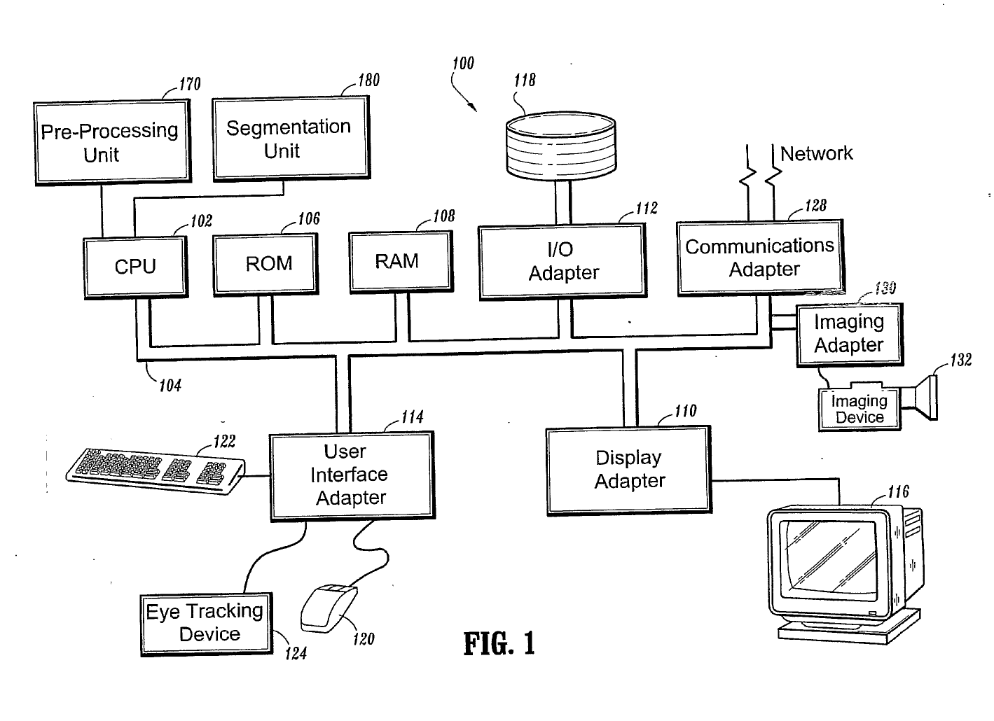

As shown in FIG. 1, a system for vessel segmentation in CTA data sets using vesselness and edgeness, according to an illustrative embodiment of the present disclosure, is indicated generally by the reference numeral 100. The system 100 includes at least one processor or central processing unit (CPU) 102 in signal communication with a system bus 104. A read only memory (ROM) 106, a random access memory (RAM) 108, a display adapter 110, an I/O adapter 112, a user interface adapter 114, a communications adapter 128, and an imaging adapter 130 are also in signal communication with the system bus 104. A display unit 116 is in signal communication with the system bus 104 via the display adapter 110. A disk storage unit 118, such as, for example, a magnetic or optical disk storage unit is in signal communication with the system bus 104 via the I/O adapter 112. A mouse 120, and a keyboard 122 are in signal communication with the system bus 104 via the user interface adapter 114. An imaging device 132 is in signal communication with the system bus 104 via the imaging adapter 130.

A pre-processing unit 170 and a vessel segmentation unit 180 are also included in the system 100 and in signal communication with the CPU 102 and the system bus 104. The exemplary pre-processing unit 170 includes a CTA pre-filtering portion, a multi-level vesselness computation portion, and an edgeness filter portion. The exemplary vessel segmentation unit 180 includes an integration portion for integrating vesselness and edgeness information. While the pre-processing unit 170 and the vessel segmentation unit 180 are illustrated as coupled to the at least one processor or CPU 102, these components are preferably embodied in computer program code stored in at least one of the memories 106, 108 and 118, wherein the computer program code is executed by the CPU 102. As will be recognized by those of ordinary skill in the pertinent art based on the teachings herein, alternate embodiments are possible, such as, for example, embodying some or all of the computer program code in registers located on the processor chip 102. Given the teachings of the disclosure provided herein, those of ordinary skill in the pertinent art will contemplate various alternate configurations and implementations of the pre-processing unit 170 and the multi-level vesselness computation unit 180, as well as the other elements of the system 100, while practicing within the scope and spirit of the present disclosure.

Preferred embodiments of the present disclosure provide a fast and robust method for CTA vessel segmentation using a two-step procedure, a pre-processing step and an interactive segmentation step. During the pre-processing step, a vesselness volume is computed by using a Hessian filter preceded by a CTA pre-filter. In order to enhance different size vessels, a Multum In Parvo (MIP) volume pyramid is created and multi-level vesselness is computed and merged. In addition, an edgeness volume, including the boundary information, is calculated and integrated with vesselness into an intermediate volume for vessel segmentation. At the interactive stage, a vessel central axis (VCA) is tracked and shown in real time by each click. After being initialized by VCAs, the system may take up to several seconds to finish vessel segmentation. This method has been successfully implemented in CTA vessel extraction and evaluation due to its ease of use and reproducibility.

CTA data sets are the exemplary context of the presently disclosed vessel segmentation method. The provided histogram-analysis based CTA pre-filter and fast vesselness computation method are adaptable to CTA datasets. Based on vesselness and edgeness, a fast front propagation method is presented to segment vessels with minimal user interaction.

Embodiments of this disclosure focus on the following aspects of the presently disclosed method. A fast multi-level vesselness computation method is used. A preferred multi-level vesselness computation method uses a MIP-volume pyramid. In addition, it achieves the maximum response by filtering CTA data sets, called “CTA pre-filtering”, before applying Hessian filtering.

The Computation of Multilevel Vesselness is now described. A vessel is considered as a linear or tubular structure. Using a multi-scale line filter to detect or enhance tubular structures is one of the most popular methods, especially in 3D. Vesselness is a grade to assess tubular structures. The higher vesselness a voxel has, the greater the probability that it belongs to a tubular structure. Although not all of the tubular structures in vascular imaging are vessels, one can discriminate vessels from their surroundings with vesselness.

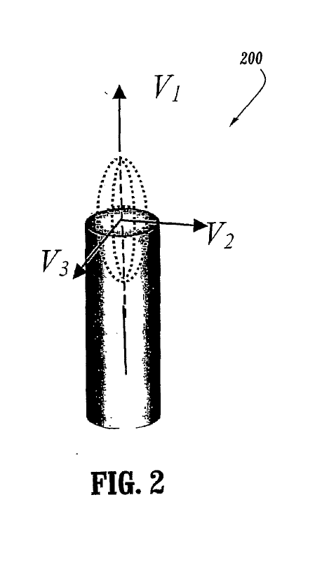

Turning to FIG. 2, a vessel model with a Gaussian luminance profile is indicated generally by the reference numeral 200. The vessel model 200 supposes that a vessel model is a cylinder in which the Z-axis is the vessel central axis and the x-y plane is the vessel cross-section with Gaussian distribution, I₀.

$${I}_{0} ( x , y , z ) = \frac{c}{2 π {σ}^{2}} {ⅇ}^{- \frac{{x}^{2} + {y}^{2}}{2 {σ}^{2}}} \qquad Eqn . 1$$

The Hessian matrix H is given by

$$H = \vert \begin{matrix}{I}_{xx} & {I}_{xy} & {I}_{xz} \\ {I}_{yx} & {I}_{yy} & {I}_{yz} \\ {I}_{zx} & {I}_{zy} & {I}_{zz}\end{matrix} \vert , where {I}_{xx} = \frac{{\partial }^{2}}{\partial {x}^{2}} I , {I}_{xy} = \frac{{\partial }^{2}}{\partial x \partial y} I , and so on .$$

The three eigenvalues and eigenvectors of the Hessian matrix H are

$${λ}_{1} = 0 , {\vec{v}}_{1} = ( 0 , 0 , 1 ) ; \\ {λ}_{2} = - \frac{{I}_{0}}{{σ}^{2}} , {\vec{v}}_{2} = ( x , y , 0 ) ; {λ}_{3} = - \frac{{I}_{0}}{{σ}^{2}} , {\vec{v}}_{3} = ( - y , x , 0 ) ; \qquad Eqn . 2$$

in which V₁, V₂ and V₃ are vectors perpendicular to each other.

Based on this model, vesselness is scaled by the linearity of π₁ with π₂ and π₃, i.e., π₁≈0 and π₃≦π₂<<0, and the symmetry of π₂ and π₃, i.e., π₂/π₃≈1.

Different functions may be designated for Sₗᵢₙₑ and S_{symm}. For example, an exponent function or a polynomial function may be used. One issue with vesselness computations is that of the computational cost. The multi-scale convolutions of 2^{nd} derivatives can be very computational costly. The desire to reduce the computational cost without loss of vesselness quality is one of the main challenges in vesselness computation.

Experiments have been reported with methods using magnetic resonance angiography (MRA) data sets, including a head MRA case and a Carotid MRA case. In a later experiment, a bronchial case with threshold −180 HU and a liver CTA case with threshold range of 0 HU≈300 HU were discussed. Both cases had no adjacent bony structures and ignored calcium. Since some bones have tubular shapes, such as ribs compared to aorta, how to reduce the false-positive vesselness is another challenge to computing vesselness in CTA.

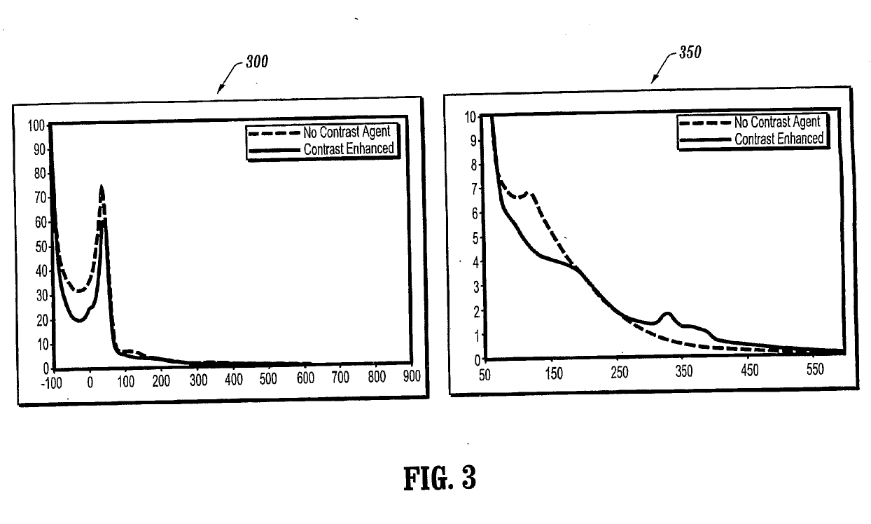

Turning now to FIG. 3, CTA Pre-filtering is now described with respect to histograms from an aorta CTA scanning with and without contrast agent, which are indicated generally by the reference numerals 300 and 350, respectively. The histograms 300 and 350 provide a comparison of an aorta CTA scanning with and without contrast agent, where the dashed line is the histogram scanned before injecting contrast agent, and the solid line the histogram scanned after injection.

In CTA scanning, an iodinated contrast bolus is injected into a large vein and rapidly circulates through the heart and then reaches the arterial vessels. The histograms of FIG. 3 show the effect of an IV contrast bolus in an abdominal ° CTA case. The histogram 300 has a range from −100 HU to 900 HU. The dashed line is the histogram before injecting contrast agent. The solid line is the result of contrast enhanced scanning. From the overview of both histograms, one can observe the shift of voxels in a low intensity range [−100, 0] to a high intensity range [50,500]. Thus, the range of Houndsfield units is markedly changed or enhanced.

An iodine contrast agent does help to distinguish vessels, but a vessel's intensity range still overlaps with other structures, especially lower-density bone and marrow. For example, when the vertebral artery goes through the cervical spines, or the anterior tibial artery is in close proximity to the tibia, they have a similar intensity range as bone surfaces such as low-density bone. Due to timing control and circulation of the contrast agent caused by plaques in vessels, the intensity of enhanced vessels is quite variable, from 100 HU to 600 HU. Because of this, a simple thresholding will not work well or consistently in CTA cases.

The other obstacle of CTA vesselness computation is that in heavily diseased arteries, calcium and other hard plaque adheres to the vessel wall and changes the local intensity profile, which makes it very difficult to compute the right eigenvalues and eigenvectors of the local Hessian matrix. Because high-density bone and calcification share the same intensity range, vesselness becomes discontinued or broken as a result of thresholding. Ideally, one would like to keep the calcium within vessels as parts of vessels segmented. However, a Hessian matrix will have difficulties in getting the right response when encountering hard plaques.

An ideal vessel model is a Gaussian luminance profile, such as described by Equation 1, where the highest intensity is at the middle of the tube and the intensity declines based on the Gaussian function at the boundary. However, this does not occur in CTA clinical practice, and one cannot directly apply the Hessian filter. Therefore, CTA data sets need a pre-filtering step to enhance the potential tubular structures before calculating vesselness. This CTA pre-filter should satisfy the following requirements: Keep the Gaussian shape vessel luminal profile; adjust the volume intensity so that the maximum intensity within the vessels lumen becomes the maximum intensity of the volume; and normalize the intensity in order to compare the vesselness from different locations.

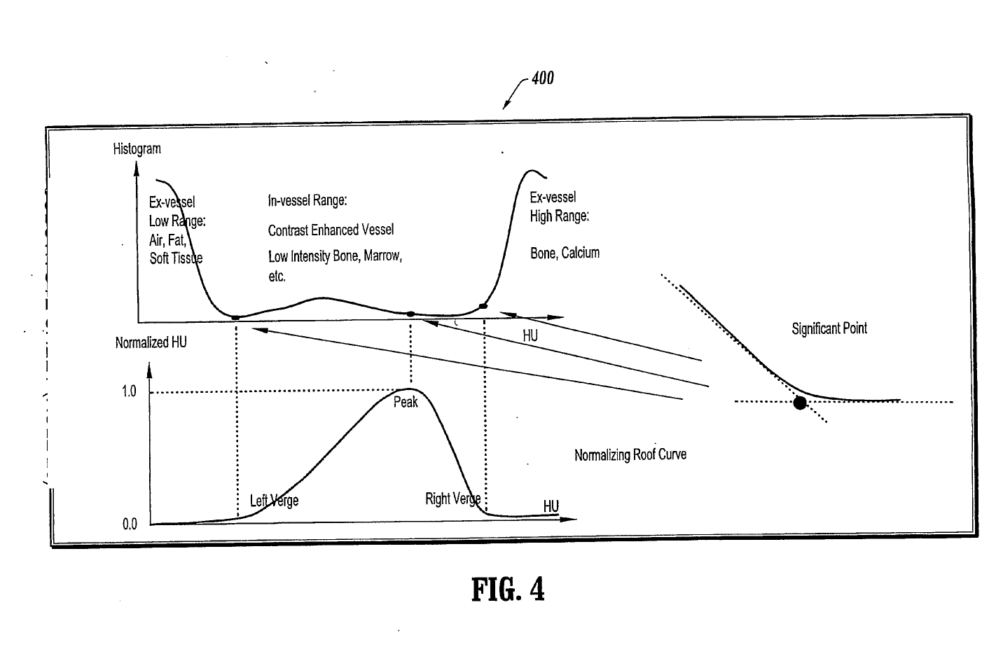

As shown in FIG. 4, three CTA intensity ranges and the Significant Point in each range are indicated generally by the reference numeral 400. A quadratic curve, called the Normalizing Roof Curve (NRC), is approximated by these three feature points. A look-up table based on NRC is calculated and used to map the original volume to keep the In-range voxels and dehance the Ex-vessel Low (ExL) range and Ex-vessel High (ExH) range voxels.

Thus, the CTA histogram can be categorized into three ranges: Ex-vessel Low (ExL) range including air, fat and soft tissue; In-vessel (In) range including contrast enhanced vessel, low intensity bone and marrow etc.; and Ex-vessel High (ExH) range including bone and calcium. At both ends of each range, there is a Significant Point (SP). At this point, the slope changes significantly because the Region In Range (RIR) reduces considerably. SP is regarded as the statistical threshold to sort the different materials in the histogram. The SP is calculated by the intersection of two asymptotes, which are approached by tangent lines. In each range, one can calculate a pair of SP points Δ(SP₀, SP₁). From SP₀ the corresponding RIR starts growing massively. After SP₁, the growing of RIR vanishes.

Since the histogram is separated into three ranges, three SP point pairs are calculated, i.e. Δ_{ExL}(SP₀, SP₁), Δₗₙ (SP₀, SP₁), Δ_{ExH}(SP₀, SP₁). The pre-filter is set up as a roof-shape curve, specifically:

Set SP₁ in Δₗₙ at the Peak Point

Set SP₀ in Δₗₙ at Left Verge Point

Set SP₀ in Δ_{ExH} at Right Verge Point

Multi-level filtering is now described. The linear filter is basically a multi-scale filter. That is, it filters with different radii (σ) convolved at each voxel in the volume, and the maximum response is chosen as the vesselness at the current voxel. However, generally speaking, a vessel's radius can differ by as few as several voxels for a coronary artery, and up to a hundred voxels for an abdominal aorta. Therefore, a multi-scale filter must calculate all sizes in order to find the maximum response. On the other hand, large-scale filtering is very time consuming.

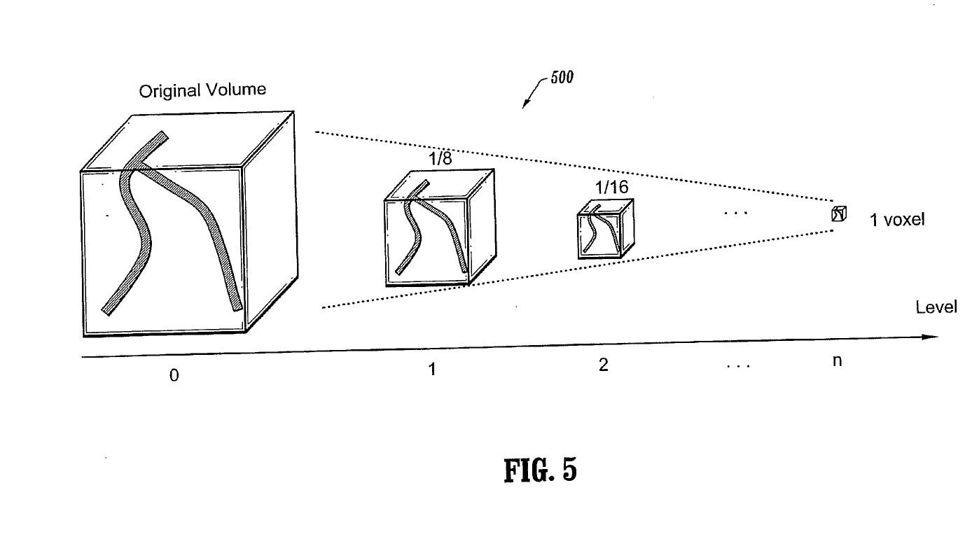

Turning to FIG. 5, a multi-level filter is indicated generally by the reference numeral 500. In a multi-level filter, a volume pyramid is created based on the original volume, called the Multum In Parvo (MIP) Volume. An MIP structure is widely used in computer graphics for 2D texture mapping, (MIP map). In an MIP Volume, Level 0 is the original volume. The next level volume stores voxels recursively with half of the pre-level volume size, e.g., filtering or averaging over every 2×2×2 voxel. This process can reduce the volume size to one voxel or a certain level. With this volume pyramid, one can reconstruct any volume for which the size falls between two integral levels. Every voxel can be interpolated with 16 nearest voxels to its neighbor integer level volumes, for 8 voxels on each level.

Instead of using a multi-scale filter, a filter with fixed scale is used in multi-level filtering. The size of the filter is set up based on the smallest vessel expected in the original volume, such as, for example, a 5-voxel-diameter vessel. Then, the same filter is applied to compute the vesselness in other levels, such as 1.5, 2.0, . . . etc. The resulting volume is scaled down to the 0-level size. Finally, results from all levels are merged into the 0-level volume by a maximum operator.
V=max(Vₗ), l=0, 0.5, 1.0, 1.5 Eqn. 3

Calculating the vesselness using a multi-level filter avoids the time-consuming convolution of large-scale filters. The disadvantage is that it may introduce blurring in the resulting vesselness volume. Blurriness within vessels will not affect propagation or segmentation. If one can keep a sharp vesselness near a boundary, segmentation will get the same results as a multi-scale filter. In order to reduce the blurring near a boundary a gradient weight function is used before high-level vesselness is scaled down to 0-level.
vₗ⁰=(1.0−gradient)*vₗ Eqn. 4

Front Propagation based on Vesselness is now described. Front propagation is an efficient fast marching level set method to track the monotonic advance of interfaces with a speed that does not change its sign, either expanding or shrinking. A front propagation is introduced in which the speed function is defined on vesselness.

Briefly, one can formalize the front propagation as the evolving function ψ, namely:
ψₜ+F″∇ψ|=0 Eqn. 5

where F is the speed function.

Letting ┌ be defined as the implicit function such that ┌ₜ={ψₜ+F|∇ψ|=0}, it is shown:

$$\frac{\partial ψ}{\partial t} = - F \vert ▽ψ \vert , where \frac{\partial Γ}{\partial t} = - FN , N = \frac{▽ψ}{\vert ▽ψ \vert} \qquad Eqn . 6$$

Thus, the evolution of zero level-set of ψₜ equals the evolution of ┌ₜ, a time-dependent implicit surface representing the evolving segmentation interface.

Considering the special case of a monotonically advancing surface, such as for a front propagation, the speed function F is always positive and the normal vector N is always pointing outwards. Instead of numerical approximating the derivatives in Equation 5, one may explicit construct and update the front interface ┌ₜ with Equation 6.

Timer-Tag Narrow Band is now described. The point to explicit construction of ┌ₜ is to create an active working zone, called a “narrow band”, a local region around the front. The narrow band is constructed by active seeds. Each seed is defined by a vector of (P, t), of which P is the target position and t is the Timer. It explains that the current seed will take t-time to arrive at target position P. When t is positive, this seed is active. When t is less than or equal to zero, this seed is deactivated and merged into ┌ₜ.

The narrow band is maintained by a heap data structure sorted by a timer t, called a “front-seed heap”. The seed with smallest t is at the top of the heap. At each time step, the heap is checked and the front interface is marching outwards as below:

For all seeds, decrease t

For all the seeds of which t≦0:
remove it from heap
merge it into ┌ₜ
insert its neighbors into the heap

Check the left seeds in heap of which t>0:
If P is in ┌ₜ, remove the seed from the heap

For each neighbor point NB of front point P, such as 6-neighbors, 18-neighbors, or 26-neighbors, the method checks only the outside NB, i.e., outside the ┌, and initializes its timer with Equation 7:

$$t = \frac{{\vert \vec{L} \vert}^{2}}{( \vec{L} \cdot \vec{N} ) F} , where \vec{L} = NB - P , F is the speed at point P \qquad Eqn . 7$$

The NB position and t are stored in the seed, and the seed is inserted into the front-seed heap.

A speed function is now described, which defines the motion of the front. In order to segment vessels, a proper speed function is needed, which increases closing to the central part of vessels and vanishes at the boundary of vessels. Most speed functions are defined directly on original images. A new speed function is now introduced that is defined based on vesselness.

Two motions affect the speed function F in Equation 7, motion by curvature term K_{ψ} and motion by the image term F_{I}.
F=(1.0−εK_{ψ})F_{I}, Eqn. 8

where K_{ψ} is mean curvature and

$${K}_{ψ} = ▽ \cdot ( \frac{▽ψ}{\vert ▽ψ \vert} ) ,$$

ε is the front smoothness control factor.

Mostly, the F_{I} term is directly calculated from an original image by gradients, called static speed. Considering the vesselness, gradient and zero-crossing, a speed volume is initialized by using these two volumes.

$${F}_{I} = \frac{1.0}{1.0 + C \vert grad \vert} ( {I}_{vesselness} + {I}_{cons} ) \qquad Eqn . 9$$

where I_{cons} is a constant term to keep the front moving. Near the zero-crossing points, this term is vanished.

Since gradient and zero-crossing points are calculated while computing vesselness, instead of calculating F_{I} on fly, a speed volume is integrated and saved directly after vesselness is calculated. By using the gradient and zero-crossing, the vesselness that might be blurred by the multi-level filter is converted to a sharpening speed at object boundaries.

Front Initialization is now described. The front is initialized by the vessel central axis (VCA) tracked in speed volume. In order to minimize user interaction, VCA is tracked based on the primary direction V₀ in a Hessian matrix (see Equation 2) from a user click. The VCAs along both primary directions (±V₀) are tracked. Unlike most ridge-tracking algorithms, preferred embodiments use a single-scale Hessian filter to estimate the primary direction, the same scale as used to calculate the vesselness. Advantages include:

The vesselness or speed volume is already centralized, and single-scale is usually enough to track a VCA.

VCA is used as an initial front to segment a vessel. Basically, if the initial front is located within a vessel, the results segmented by front propagation stay the same. That is to say, initial position is not critical to segmentation results.

In addition, the VCA can be trimmed off when two central axes are close enough in space, that is, they can be merged into one central axis. The VCA always follows the directions of user clicks. At bifurcations, the user can control the vessel segmentation by selecting the interested branches. Since the VCA is tracked and displayed in real time, it gives the user an overview to interrogate the vessel that is going to be segmented.

The exemplary method embodiment is integrated into an exemplary vascular measurement system and has been validated by CTA scannings from different parts of body and from different clinical institutions.

While exemplary embodiments have been described for use with CTA data sets, it will be recognized by those of ordinary skill in the pertinent art that alternate embodiments may be used for MRA, X-Ray Angiography (XRA) and Digital Subtraction Angiography (DSA) data sets, for example, even though MRA data sets may not show calcium deposits and bone. In addition, while the exemplary embodiments have been described as pre-processing values prior to segmentation, the values may alternately be computed during segmentation. In other words, the pre-processing and segmentation processes may be performed at the same time, wherein the vessel segmentation process directs the pre-processing of certain regions of the image volume data, as the user selects certain regions for segmentation (e.g., clicking on a region of a displayed image to segment a desired vessel or portion of the vessel). An advantage of this alternate embodiment is that only the values actually required for a selected segmentation would need to be computed for that segmentation.

In other exemplary embodiments of the invention, a vessel segmentation and visualization system according to the invention enables selection and storage of multiple blood vessels for rapid reviewing at a subsequent time. For instance, a plurality of blood vessels that have been previously segmented, processed, annotated, etc. can be stored and later reviewed by selecting them one after another for rapid review. By way of further example, a plurality of different views may be simultaneously displayed in different windows (e.g., curved MPR, endoluminal view, etc.) for reviewing a selected blood vessel. When a user selects another stored (and previously processed) blood vessel, all of the different views can be updated to include an image and relevant information associated with the newly selected blood vessel. In this manner, a user can select one or more multiple views that the user typically uses for reviewing blood vessels, for instance, and then selectively scroll through some or all of the stored blood vessels to have each of the views instantly updated with the selected blood vessels to rapidly review such stored set of vessels.

The foregoing merely illustrates the principles of the disclosure. It will thus be appreciated that those skilled in the art will be able to devise numerous systems, apparatus and methods which, although not explicitly shown or described herein, embody the principles of the disclosure and are thus within the spirit and scope of the disclosure as defined by its Claims.

For example, the methods and systems described herein could be applied to virtually examine an animal, fish or inanimate object. Besides the stated uses in the medical field, applications of the technique could be used to detect the contents of sealed objects that cannot be opened. The technique could also be used inside an architectural structure such as a building or cavern and enable the operator to navigate through the structure.

These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (CPU), a random access memory (RAM), and input/output (I/O) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which embodiments of the present disclosure are programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present disclosure. All such changes and modifications are intended to be included within the scope of the present invention as set forth in the appended Claims.

What is claimed is:

1. A system for vessel segmentation, comprising:
at least one input adapter for receiving image data;
a processor in signal communication with the at least one input adapter;
a pre-processing unit in signal communication with the processor for pre-processing the received image data; and
a vessel segmentation unit in signal communication with the processor for segmenting vessels using pre-processed data.

2. A system as defined in claim 1 wherein the image data is a computerized tomographic angiography (“CTA”) data set, the pre-processing unit comprising:
a CTA pre-filtering portion in signal communication with the processor for pre-filtering the CTA data set;
an edgeness filtering portion in signal communication with the processor for calculating the boundary information; and
a multi-level vesselness computation portion in signal communication with the processor for computing the multi-level vesselness.

3. A system as defined in claim 2, the multi-level vesselness computation portion comprising a Multum In Parvo (“MIP”) volume pyramid portion.

4. A system as defined in claim 2 wherein the CTA pre-filtering portion is automatic for enhancing the vesselness response in CTA data sets.

5. A system as defined in claim 2 wherein the CTA pre-filtering portion is responsive to anatomic regions that are at least one of specified by a user and automatically determined.

6. A system as defined in claim 2 wherein every voxel in the CTA dataset can be pre-assigned with a probability of being part of a vessel.

7. A system as defined in claim 6 wherein the pre-assigned probability of a voxel being part of a vessel is determined by at least one of three-dimensional (“3D”) shape, voxel intensity, derivatives of the intensity, and texture.

8. A system as defined in claim 2 wherein the multi-level vesselness computation portion uses vesselness as a vessel enhancement method in CTA data sets to improve segmentation.

9. A system as defined in claim 1, further comprising a display adapter (110) in signal communication with the processor for providing a visualization of vasculature responsive to the multi-level vesselness computation portion.

10. A system as defined in claim 2 wherein the edgeness filtering portion computes the boundary information of objects.

11. A system as defined in claim 1, the vessel segmentation unit having an integration portion for integrating vesselness and edgeness information to segment vessels using vesselness and edgeness.

12. A system as defined in claim 1 wherein the vessel segmentation unit provides a separation of vasculature from non-vasculature such as bones and soft tissue.

13. A system as defined in claim 1 wherein the vessel segmentation unit provides a segmentation of vasculature and other objects similar to vessels or tubes, such as a spinal column.

14. A system as defined in claim 1 wherein the vessel segmentation unit provides a segmentation of non-vasculature such as bones and soft tissue.

15. A method of vessel segmentation, comprising:
receiving image data;
pre-processing the received data; and
segmenting vessels responsive to the pre-processed data.

16. A method as defined in claim 15 wherein:
the image data is a computerized tomographic angiography (“CTA”) data set; and
pre-processing includes at least one of pre-filtering the received data, computing the multi-level vesselness, and computing the edgeness.

17. A method as defined in claim 15 wherein segmenting vessels is responsive to the computed vesselness and to the computed edgeness.

18. A method as defined in claim 16 wherein computing the multi-level vesselness includes using a Multum In Parvo (“MIP”) volume pyramid.

19. A method as defined in claim 16 wherein pre-filtering the CTA data is automatic for enhancing the vesselness response in CTA data sets.

20. A method as defined in claim 16 wherein pre-filtering the CTA data is responsive to anatomic regions that are at least one of specified by a user and automatically determined.

21. A method as defined in claim 16 wherein every voxel in the CTA dataset is pre-assigned with a probability of being part of a vessel.

22. A method as defined in claim 21 wherein the pre-assigned probability of a voxel being part of a vessel is determined by at least one of three-dimensional (“3D”) shape, voxel intensity, derivatives of the intensity, and texture.

23. A method as defined in claim 16 wherein the computation of multi-level vesselness uses vesselness as a vessel enhancement method in CTA data sets to improve segmentation.

24. A method as defined in claim 15, further comprising providing a visualization of vasculature responsive to the computation of multi-level vesselness.

25. A method as defined in claim 16 wherein computing the edgeness includes filtering boundary information of objects.

26. A method as defined in claim 16 wherein the vessel segmentation unit segments vessels using vesselness and edgeness.

27. A method as defined in claim 15 wherein the vessel segmentation unit provides a separation of vasculature from non-vasculature such as bones and soft tissue.

28. A method as defined in claim 15 wherein the vessel segmentation unit provides a segmentation of vasculature and other objects similar to vessels or tubes, such as a spinal column.

29. A method as defined in claim 15 wherein the vessel segmentation unit provides a segmentation of non-vasculature such as bones and soft tissue.

30. A method as defined in claim 16, pre-filtering comprising:
maintaining a Gaussian shape vessel luminal profile;
adjusting the volume intensity so that the maximum intensity within the vessel lumen becomes the maximum intensity of the volume; and
normalizing the intensity to compare the vesselness from different locations.

31. A method as defined in claim 16, pre-filtering comprising categorizing the CTA data into three ranges.

32. A method as defined in claim 31 wherein the three ranges include an Ex-vessel Low (“ExL”) range including air, fat and soft tissue; an In-vessel (“In”) range including contrast enhanced vessel, low intensity bone and marrow; and an Ex-vessel High (“ExH”) range including bone and calcium.

33. A method as defined in claim 16 wherein pre-filtering is set up as a roof-shaped curve.

34. A method as defined in claim 16 wherein the edgeness filter computes the boundary information with a Gaussian filter.

35. A method as defined in claim 15 wherein the vessel segmentation uses front propagation with vesselness and edgeness and includes checking a seed heap and marching the front interface outwards in response to at least one seed.

36. A method as defined in claim 16 wherein the vessel segmentation uses a single-scale Hessian filter to estimate the primary direction in correspondence with the same scale as used to calculate the vesselness.

37. A method as defined in claim 36 wherein at least one of the vesselness and speed volume is centralized, and a single-scale is used to track a vessel central axis (“VCA”).

38. A method as defined in claim 37 wherein the VCA is used as an initial front to segment a vessel.

39. A method as defined in claim 38 wherein the VCA is trimmed when two central axes are close enough in space such that they can be merged into one central axis.

40. A method as defined in claim 37, further comprising receiving a plurality of user clicks such that the VCA always follows the directions of the user clicks.

41. A method as defined in claim 15, further comprising automatically extracting vessels in accordance with basic knowledge of anatomy responsive to at least one of approximate direction, curvature, and connectivity to other vessels.

42. A method as defined in claim 15 wherein the image data includes a data set obtained from at least one of computerized tomographic angiography (“CTA”), magnetic resonance angiography (“MRA”), x-ray angiography (“XRA”) and digital subtraction angiography (“DSA”).

43. A program storage device readable by machine, tangibly embodying a program of instructions executable by the machine to perform program steps for vessel segmentation, the program steps comprising:
receiving image data;
filtering the received image data;
computing multi-level vesselness of the filtered image data;
computing edgeness of the filtered image data;
segmenting at least one vessel in response to the computed vesselness and edgeness.

44. A program storage device as defined in claim 43, the program steps further comprising segmenting a vessel in correspondence with the computed multi-level vesselness for vesselness-based front propagation.
